(19) United States
(12) Patent Application Publication
(10) Pub. No.: US 2018/0161235 A1
(43) Pub. Date: Jun. 14, 2018

(54) MASSAGING DEVICE WITH REMOVABLE MASSAGE ELEMENT

(71) Applicant: Paul CHEN, Vancouver (CA)

(72) Inventor: Paul CHEN, Vancouver (CA)

(21) Appl. No.: 15/373,497

(22) Filed: Dec. 9, 2016

(51) Int. Cl. A61H 15/02

(52) U.S. Cl. CPC A61H 15/02; A61H 2201/0214; A61H 2201/0207

(57) ABSTRACT

A massaging device includes a receptacle having two members detachably secured together, the members each include a chamber, and the chambers of the members are communicating with each other for forming a space within the receptacle, and a massaging element is removably engaged in the space of the receptacle and the chambers of the members, and removable from the chambers of the members for massaging purposes. The massaging element includes a compartment for receiving a cooling agent. The receptacle includes a latch device for selectively securing the members together. The members each include a threaded member for threading with a threaded element of the latch device.

### BACKGROUND OF THE INVENTION

### 1. Field of the Invention

The present invention relates to a massaging device, and more particularly to a massaging device including an improved and simplified structure or configuration that may be easily and quickly made or manufactured or assembled by the workers and including an icy or hot or heat device or massage element removable from an outer housing for massaging the user selectively.

### 2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui, and U.S. Pat. No. 8,888,808 to Park disclose two of the typical massaging devices comprising a relatively harder or stronger inner housing having a cylindrical shape, and a relatively softer or resilient outer layer for selectively contacting or engaging with the users and for massaging purposes, and/or comprising a planar base member having a number of projections or protrusions extended outwardly therefrom for frictionally contacting or engaging with the users and for massaging purposes.

However, the typical massaging devices have no icy or heating or hot members or devices for engaging with and for massaging the user.

U.S. Design Pat. No. D549,834 to Huang discloses another typical massaging device comprising an icy roller for engaging with and for massaging the user.

However, the icy roller may not be suitably received and protected within an outer housing.

The present invention has arisen to mitigate and/or obviate the afore-described disadvantages of the conventional massaging devices.

### SUMMARY OF THE INVENTION

The primary objective of the present invention is to provide a massaging device including an improved and simplified structure or configuration that may be easily and quickly made or manufactured or assembled by the workers.

The other objective of the present invention is to provide a massaging device including an icy or hot or heat device or massage element removable from an outer housing for massaging the user selectively.

In accordance with one aspect of the invention, there is provided a massaging device comprising a receptacle including a first member and a second member detachably secured together, the first and the second members each including a chamber formed therein, and the chambers of the first and the second members being communicating with each other for forming a space within the receptacle, and a massaging element removably received and engaged in the space of the receptacle and the chambers of the first and the second members, and removable from the chambers of the first and the second members for allowing the massaging element to be easily and quickly and readily fetched by the user and removed from the first and the second members, when required, for massaging purposes.

The massaging element includes a compartment formed therein. The massaging element includes a heating agent and/or a cooling agent received and engaged in the compartment of the massaging element for allowing the massaging element to be pre-heated or pre-cooled or iced or refrigerated with a heater or refrigerator or the like. The chambers of the first and the second members may be vacuumed and/or may be filled with heat isolation material, such as Styrofoam or the like, for receiving and containing the massaging element and for suitably maintaining the heating or cooling temperature of the massaging element and for allowing the temperature of the massaging element to be kept for much longer period of time.

The receptacle includes a latch device for selectively securing and coupling the first and the second members together. For example, the first and the second members each include a threaded member formed and provided therein, and the latch device includes a threaded element for threading and engaging with the threaded members of the first and the second members and for detachably securing the first and the second members together and for allowing the first and the second members to be selectively disengaged and separated from each other.

The first and the second members each include a concave inner surface and an opened peripheral lip portion for forming or defining the chamber of the first and the second members respectively, and the threaded members are preferably formed in the peripheral lip portions of the first and the second members respectively for threading and engaging with the threaded element of the latch device and thus for detachably securing the first and the second members together.

The second member includes a locking device for selectively engaging with the first member and for selectively anchoring and supporting the first member on the second member. For example, the first member includes a groove formed therein for selectively engaging with the locking device. The second member includes a spring biasing member engaged with the locking device for biasing and forcing and engaging the locking device into an opening of the second member.

The second member includes an opening formed therein for slidably receiving and engaging with the locking device and for allowing the locking device to be selectively extended out of the opening of the second member. The second member includes at least one projection extended into the opening of the second member for contacting or engaging with the locking device and for limiting the movement of the locking device relative to the second member and for preventing the locking device from being disengaged from the second member, and the locking device includes at least one notch formed therein for slidably engaging with the projection of the second member and for allowing the locking device to be partially extended out of the opening of the second member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a massaging device in accordance with the present invention, as seen from the upper portion of the massaging device;

FIG. 2 is a cross sectional view of the massaging device, taken along lines 2-2 of FIG. 1;

FIG. 3 is a partial exploded view of the massaging device;

FIG. 4 is another exploded view as seen from the upper portion of the massaging device;

FIG. 5 is a further exploded view as seen from the bottom portion of the massaging device;

FIG. 6 is an exploded and cross sectional view of the massaging device;

FIG. 7 is a perspective view illustrating the operation of the massaging device;

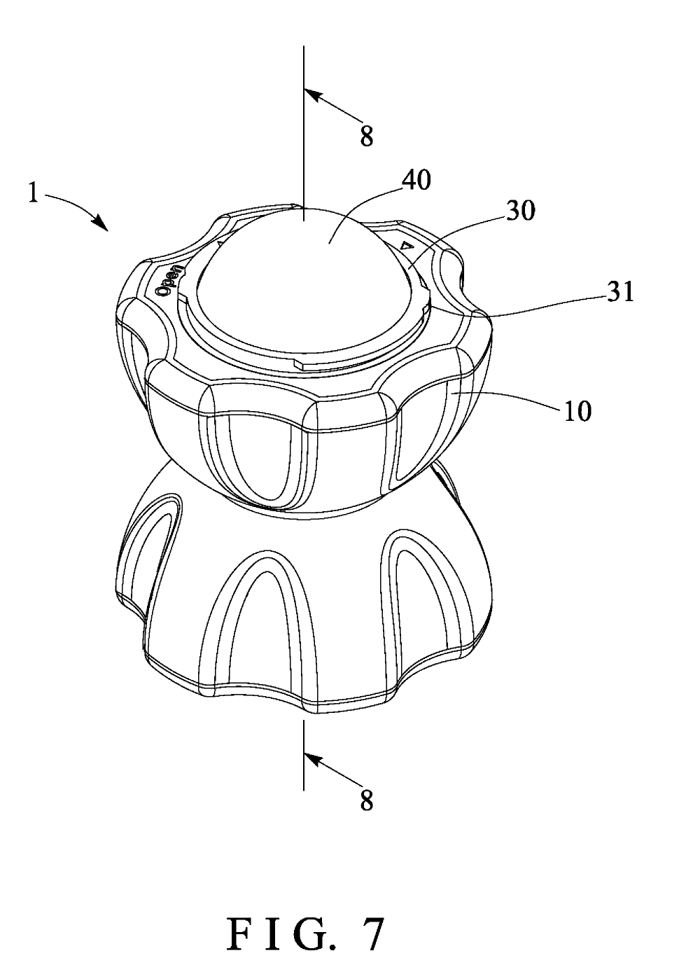

FIG. 8 is a cross sectional view of the massaging device, taken along lines 8-8 of FIG. 7; and

FIG. 9 is another partial exploded view illustrating the operation of the massaging device.

### DETAILED DESCRIPTION OF THE PREFERRED EMBODIMENT

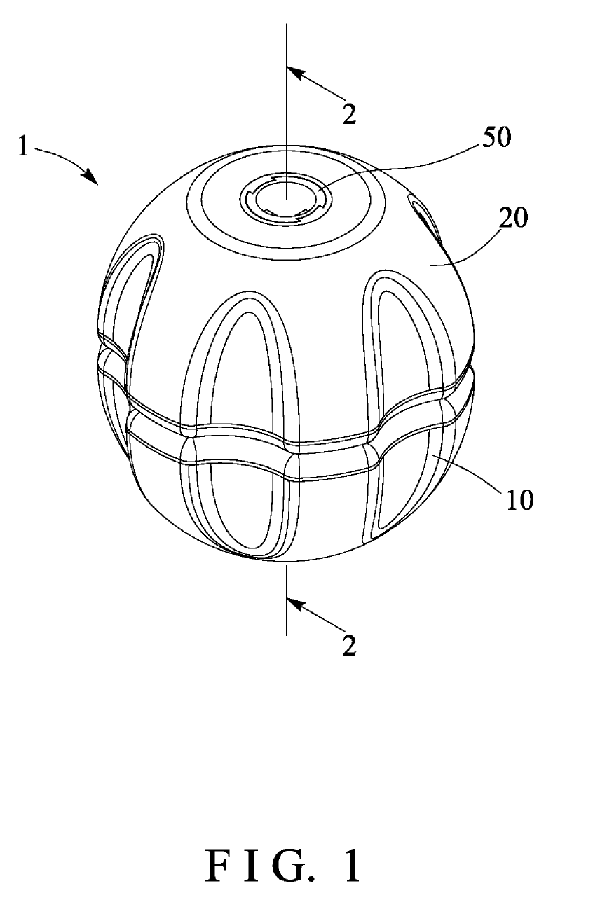

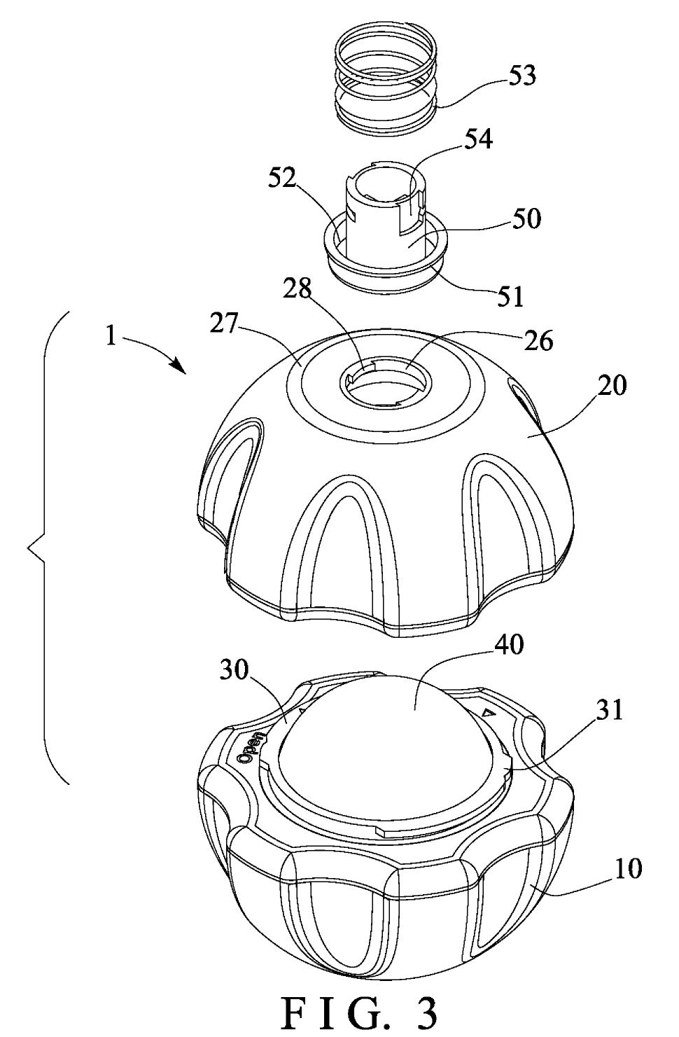

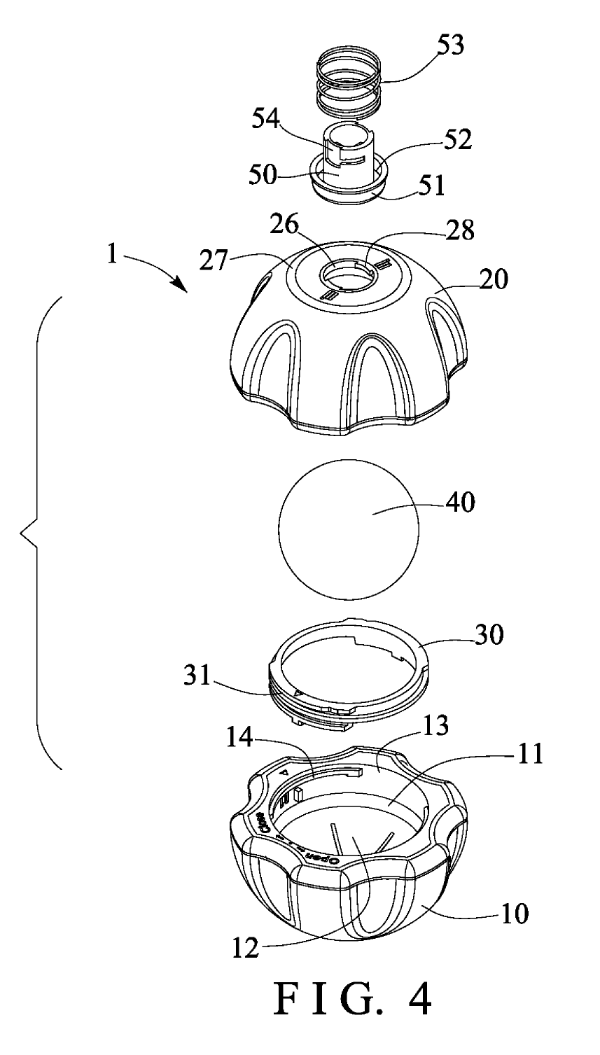

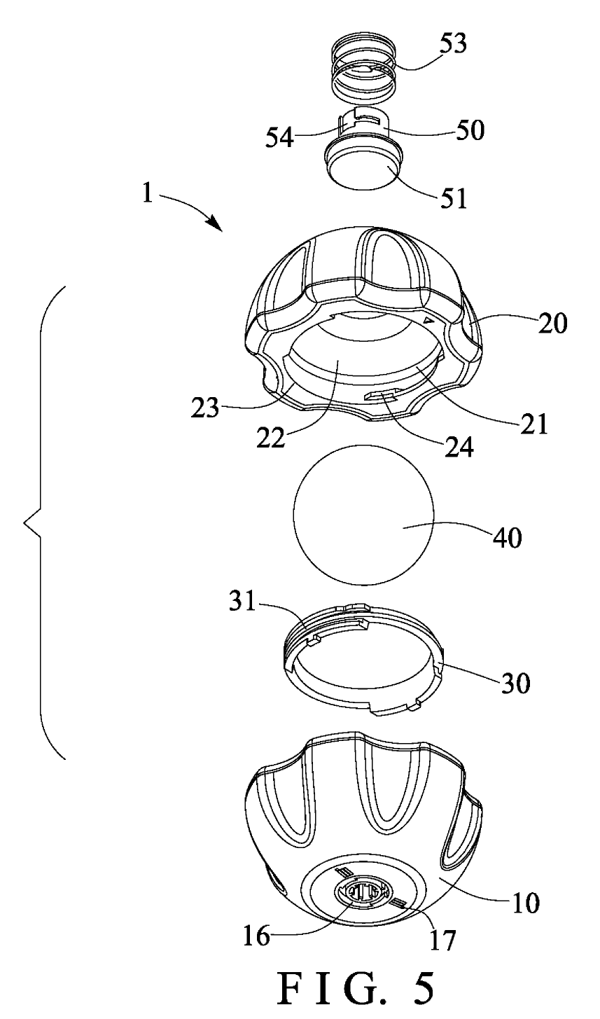

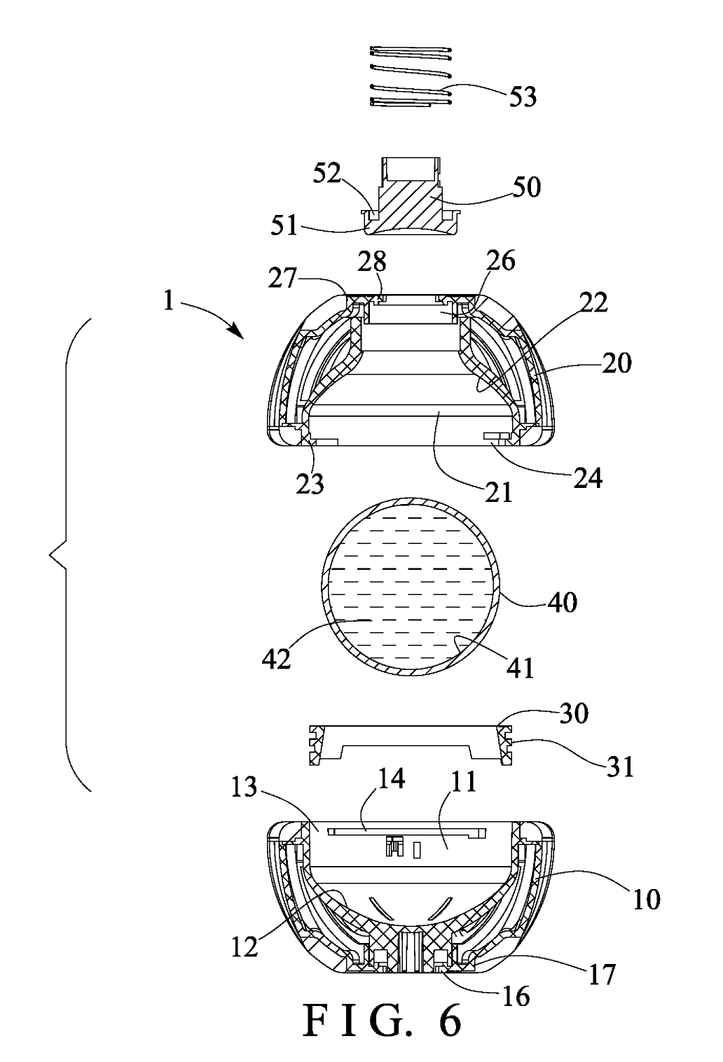

Referring to the drawings, and initially to FIGS. 1-6, a massaging device in accordance with the present invention comprises an outer housing or receptacle 1 including a base or lower or first member 10 and a cover or upper or second member 20 disengaged or separated from each other, and detachably or removably secured or coupled together with a threaded or latch device 30. It is preferable, but not necessary that the first and the second members 10, 20 each include a semi-spherical structure or configuration having a compartment or chamber 11, 21 formed therein and defined by a concave or semi-spherical inner surface 12, 22 and having an opened peripheral or lip portion 13, 23, and each include an inner threaded portion or member 14, 24 formed or provided in the opened lip portion 13, 23 thereof.

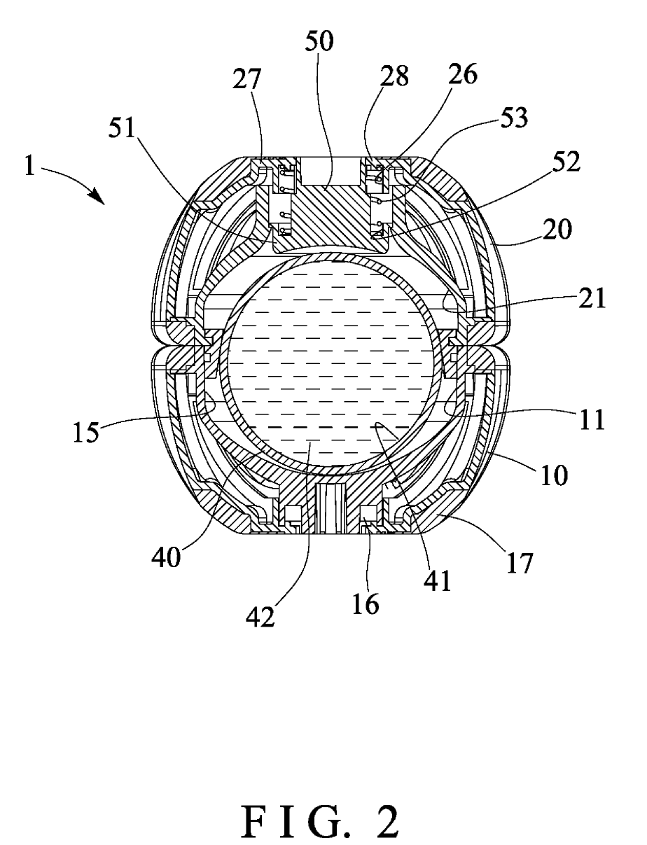

The latch device 30 includes an outer threaded portion or element 31 formed or provided on the outer peripheral portion thereof for threading or engaging with the threaded members 14, 24 of the first and the second members 10, 20 and for detachably or removably securing or coupling the first and the second members 10, 20 together, and for forming or defining a substantially spherical compartment or space 15 within the outer housing or receptacle 1, and for detachably or removably receiving or engaging with an inner massaging element 40; i.e., the chambers 11, 21 of the first and the second members 10, 20 are communicating with each other for forming or defining the space 15 within the receptacle 1. It is preferable, but not necessary that the massaging element 40 includes a spherical structure or configuration having a space or compartment 41 formed therein (FIG. 2) for receiving or engaging with a heating agent and/or a cooling agent 42 or the like.

For example, the massaging element 40 with the heating agent or cooling agent 42 may be pre-heated with hot water or with microwave or the like, or pre-cooled or iced or refrigerated with a refrigerator or the like (not illustrated) before disposed or engaged into the space 15 of the receptacle 1 and/or the chambers 11, 21 of the first and the second members 10, 20. It is preferable, but not necessary that the first and the second members 10, 20 are made of heat preserving materials, such as rubber, plastic, composite materials or the like for suitably preserving the cooling temperature of the cooling agent 42 of the massaging element 40. When the massaging element 40 is disengaged or separated from the receptacle 1 and/or the first and the second members 10, 20, the massaging element 40 may be used for engaging with and for massaging the user selectively.

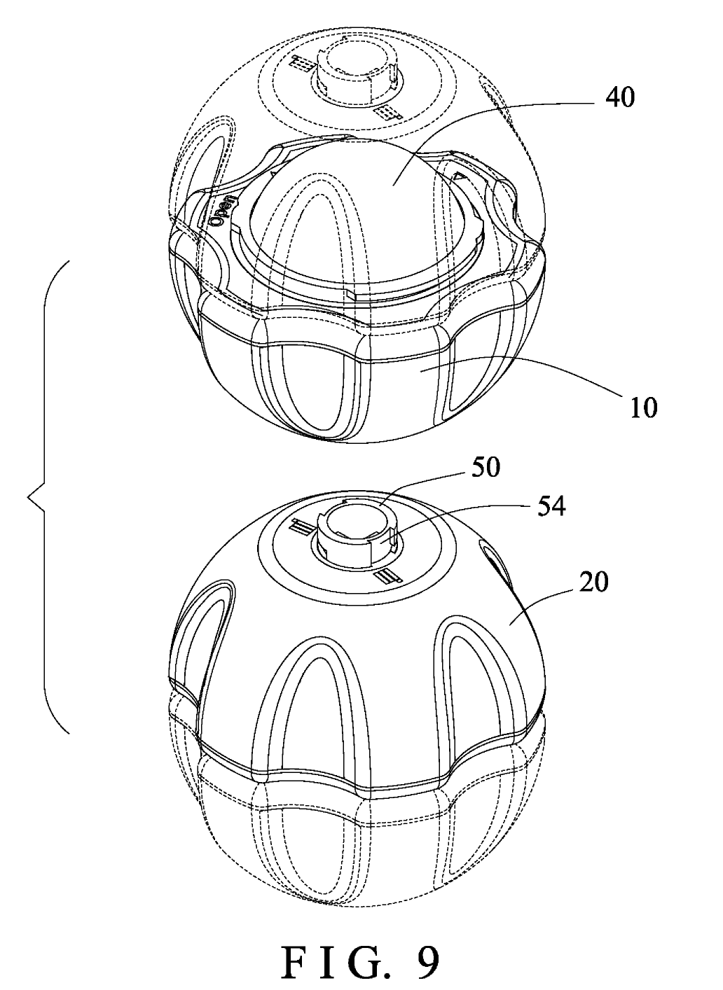

As shown in FIGS. 2 and 5-6, the base or lower or first member 10 further includes a circular or peripheral channel or groove 16 formed in the lower or bottom portion 17 thereof and offset or spaced or separated from the chamber 11 of the first member 10, and the cover or upper or second member 20 further includes an opening 26 formed therein, such as formed in the upper portion 27 thereof and communicating with the chamber 21 of the second member 20 for slidably receiving or engaging with an anchoring or locking device 50 and arranged for allowing the locking device 50 to be selectively extended out of the opening 26 of the second member 20 (FIG. 9), and one or more (such as two) latches or projections 28 extended radially and inwardly into the opening 26 of the second member 20.

The locking device 50 includes a peripheral flange or skirt 51 extended radially and outwardly therefrom for forming or defining a peripheral shoulder or recess 52 therein and for receiving or engaging with a spring biasing member 53 which is contacted or engaged with the second member 20, such as engaged with the projections 28 of the second member 20 and also contacted or engaged with the peripheral flange 51 of the locking device 50 for biasing and forcing or moving the locking device 50 into the opening 26 and/or the chamber 21 of the second member 20 (FIG. 2). The projections 28 of the second member 20 may be contacted or engaged with the locking device 50 for limiting the movement of the locking device 50 relative to the second member 20.

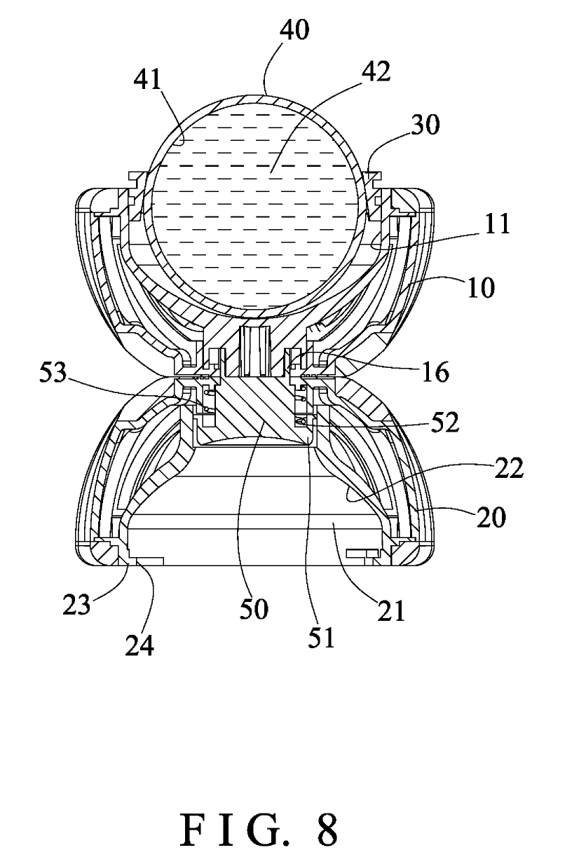

The locking device 50 further includes one or more (such as two) slots or notches 54 formed therein for slidably receiving or engaging with the projections 28 of the second member 20 and for allowing the locking device 50 to be selectively and partially extended out of the opening 26 of the second member 20 (FIG. 9), and arranged for allowing the locking device 50 to be selectively engaged into the groove 16 of the first member 10 (FIG. 8), and for solidly and stably anchoring and supporting the first member 10 on the second member 20, and/or for supporting the massaging element 40 on the first member 10, and thus for allowing the massaging element 40 to be easily and quickly and readily fetched by the user when required. None of the typical massaging devices taught and provided a massaging element 40 received or engaged in an outer housing or receptacle 1 that includes a first and a second member 10, 20 disengaged or separated from each other, and detachably or removably secured or coupled together with a latch device 30.

When the massaging element 40 is removed from the first and the second members 10, 20 of the receptacle 1, the first and the second members 10, 20 that are solidly and stably secured together may be used for massaging the user. It is to be noted that the massaging element 40 may be removed from the first and the second members 10, 20 of the receptacle 1 and may thus be easily cleaned for removing the bacteria that may be generated or accumulated on the massaging element 40, to improve hygiene of the user.

It is further to be noted that the space 15 of the receptacle 1 and/or the chambers 11, 21 of the first and the second members 10, 20 may be vacuumed without any air and may be filled with heat isolation material, such as Styrofoam or the like, for receiving and containing the massaging element 40 and for suitably maintaining the temperature of the massaging element 40 and thus for allowing the temperature of the massaging element 40 to be kept for much longer period of time. As shown in FIG. 9, two receptacles 1, as shown in dotted lines, may also be solidly and stably secured together and may also be used for massaging the user.

Accordingly, the massaging device in accordance with the present invention includes an improved and simplified structure or configuration that may be easily and quickly made or manufactured or assembled by the workers, and includes an icy device removable from an outer housing for massaging the user selectively.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
a receptacle including a first member and a second member detachably secured together, said first and said second members each including a chamber formed therein, and said chambers of said first and said second members being communicating with each other for forming a space within said receptacle, and
a massaging element removably received and engaged in said space of said receptacle and said chambers of said first and said second members, and removable from said chambers of said first and said second members.

2. The massaging device as claimed in claim 1, wherein said massaging element includes a compartment formed therein.

3. The massaging device as claimed in claim 2, wherein said massaging element includes a cooling agent received and engaged in said compartment of said massaging element.

4. The massaging device as claimed in claim 2, wherein said massaging element includes a heating agent received and engaged in said compartment of said massaging element.

5. The massaging device as claimed in claim 1, wherein said receptacle includes a latch device for selectively securing and coupling said first and said second members together.

6. The massaging device as claimed in claim 5, wherein said first and said second members each include a threaded member formed and provided therein, and said latch device includes a threaded element for threading and engaging with said threaded members of said first and said second members and for detachably securing said first and said second members together.

7. The massaging device as claimed in claim 6, wherein said first and said second members each include a concave inner surface and an opened peripheral lip portion for defining said chamber of said first and said second members respectively, and said threaded members are formed in said peripheral lip portions of said first and said second members respectively.

8. The massaging device as claimed in claim 1, wherein said second member includes a locking device for selectively engaging with said first member and for selectively supporting said first member on said second member.

9. The massaging device as claimed in claim 8, wherein said first member includes a groove formed therein for selectively engaging with said locking device.

10. The massaging device as claimed in claim 8, wherein said second member includes an opening formed therein for slidably receiving and engaging with said locking device and for allowing said locking device to be selectively extended out of said opening of said second member.

11. The massaging device as claimed in claim 10, wherein said second member includes at least one projection extended into said opening of said second member, and said locking device includes at least one notch formed therein for slidably engaging with said at least one projection of said second member and for allowing said locking device to be partially extended out of said opening of said second member.

12. The massaging device as claimed in claim 8, wherein said second member includes a spring biasing member engaged with said locking device for biasing and forcing said locking device into said opening of said second member.
